(19) United States
(12) Patent Application Publication
(10) Pub. No.: US 2013/0073545 A1
(43) Pub. Date: Mar. 21, 2013

(54) METHOD AND SYSTEM FOR PROVIDING RECOMMENDED CONTENT FOR USER GENERATED CONTENT ON AN ARTICLE

(71) Applicant: Vidit JAIN, Bangalore (IN)

(72) Inventor: Vidit JAIN, Bangalore (IN)

(73) Assignee: Yahoo! Inc., Sunnyvale, CA (US)

(21) Appl. No.: 13/233,380

(22) Filed: Sep. 15, 2011

(51) Int. Cl. G06F 17/30

(52) U.S. Cl. 707/732; 707/723; 707/E17.082

(57) ABSTRACT

A method and system for providing recommended content for user generated content on an article. The method includes determining one or more features of the article on a web page. The article along with a topical set of comments is viewed by a user. The method also includes defining one or more features of the topical set of comments. The method further includes retrieving the recommended content based on the one or more features of the article and the one or more features of the topical set of comments. Further, the method includes ranking the recommended content based on a plurality of parameters. The plurality of parameters includes user-intent features, a contextual user-model, user history, and user preferences. Moreover, the method includes displaying the recommended content along with the topical set of comments. The system includes one or more electronic devices, a communication interface, a memory, and a processor.

### TECHNICAL FIELD

Embodiments of the disclosure relate to the field of providing recommended content for user generated content on an article.

### BACKGROUND

Currently, there are multiple websites on the internet which enable users to post comments in response to an article or an existing comment, with an objective of voicing opinions or participating in a conversation. When creating or consuming such comments, the user can also come across a topic of conversation in the comments and can be interested in gaining information on the topic. However, there is no provision for the user to gain the information instantly which eventually leads to the user leaving a network, thereby resulting in a loss of revenue.

In the light of the foregoing discussion, there is a need for a method and system for an efficient technique to provide recommended content for user generated content on an article.

### SUMMARY

The above-mentioned needs are met by a method, a computer program product and a system for providing recommended content for user generated content on an article.

An example of a method of providing recommended content for user generated content on an article includes determining one or more features of the article on a web page. The article along with a topical set of comments is viewed by a user. The method also includes defining one or more features of the topical set of comments. The method further includes retrieving the recommended content based on the one or more features of the article and the one or more features of the topical set of comments. Further, the method includes ranking the recommended content based on a plurality of parameters. The plurality of parameters comprises user-intent features, a contextual user-model, user history, and user preferences. Moreover, the method includes displaying the recommended content, based on the ranking, along with the topical set of comments.

An example of a computer program product stored on a non-transitory computer-readable medium that when executed by a processor, performs a method of providing recommended content for user generated content on an article includes determining one or more features of the article on a web page. The article along with a topical set of comments is viewed by a user. The computer program product also includes defining one or more features of the topical set of comments. The computer program product further includes retrieving the recommended content based on the one or more features of the article and the one or more features of the topical set of comments. Further, the computer program product includes ranking the recommended content based on a plurality of parameters. The plurality of parameters comprises user-intent features, a contextual user-model, user history, and user preferences. Moreover, the computer program product includes displaying the recommended content, based on the ranking, along with the topical set of comments.

An example of a system for providing recommended content for user generated content on an article includes one or more electronic devices. The system also includes a communication interface in electronic communication with the one or more electronic devices. The system further includes a memory that stores instructions. Further, the system includes a processor responsive to the instructions to determine one or more features of the article on a web page, to define one or more features of a topical set of comments, to retrieve the recommended content based on the one or more features of the article and the one or more features of the topical set of comments, to rank the recommended content based on a plurality of parameters, and to display the recommended content, based on the ranking, along with the topical set of comments.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a block diagram of an environment, in accordance with which various embodiments can be implemented;

FIG. 2 is a block diagram of a server, in accordance with one embodiment;

FIG. 3 is a flowchart illustrating a method of providing recommended content for user generated content on an article, in accordance with one embodiment; and

FIG. 4 is a block diagram illustrating working of a ranking and recommending unit, in accordance with one embodiment.

### DETAILED DESCRIPTION OF THE EMBODIMENTS

The above-mentioned needs are met by a method, computer program product and system for providing recommended content for user generated content on an article. The following detailed description is intended to provide example implementations to one of ordinary skill in the art, and is not intended to limit the invention to the explicit disclosure, as one or ordinary skill in the art will understand that variations can be substituted that are within the scope of the invention as described.

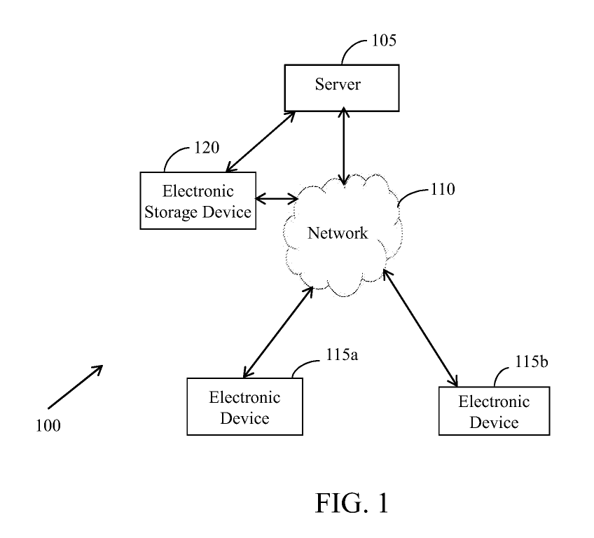

FIG. 1 is a block diagram of an environment 100, in accordance with which various embodiments can be implemented.

The environment 100 includes a server 105 connected to a network 110. The environment 100 further includes one or more electronic devices, for example an electronic device 115a and an electronic device 115b, which can communicate with each other through the network 110. Examples of the electronic devices include, but are not limited to, computers, mobile devices, laptops, palmtops, hand held devices, telecommunication devices, and personal digital assistants (PDAs).

The electronic devices can communicate with the server 105 through the network 110. Examples of the network 110 include, but are not limited to, a Local Area Network (LAN), a Wireless Local Area Network (WLAN), a Wide Area Network (WAN), internet, and a Small Area Network (SAN). The electronic devices associated with different users can be remotely located with respect to the server 105.

The server 105 is also connected to an electronic storage device 120 directly or via the network 110 to store information, for example one or more features of an article, one or more features of a topical set of comments, user-intent features, contextual user-model, user history, and user preferences.

In some embodiments, different electronic storage devices are used for storing the information.

A user of an electronic device, for example the electronic device 115a, can view an article and a topical set of comments on a web page. The topical set of comments can be defined as a semantically coherent and cohesive set of comments. The user can also view recommended content displayed as one or more links interleaved along with the topical set of comments. The recommended content is retrieved by the server 105, for example a Yahoo!® server, based on one or more features of the article and one or more features of the topical set of comments that are stored in the electronic storage device 120. The server 105 ranks the recommended content based on a plurality of parameters including user-intent features, a contextual user-model, user history, and user preferences, also stored in the electronic storage device 120. The user is enabled to choose the one or more links to gain information related to the topical set of comments. The one or more links can direct the user to a related article or another set of comments.

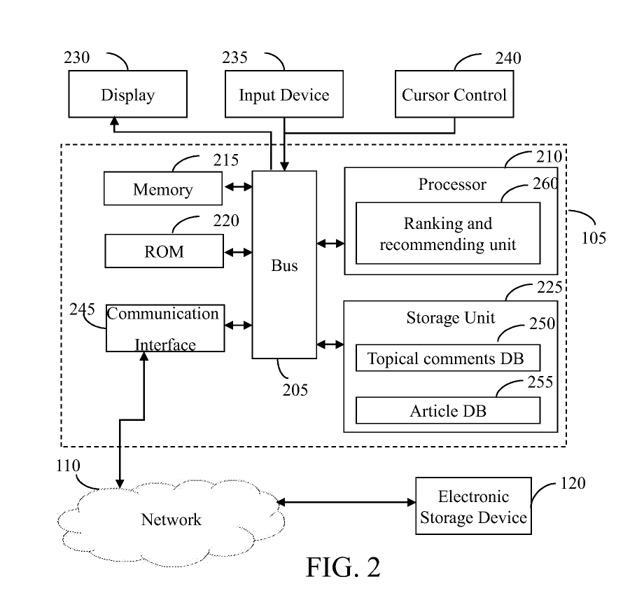

The server 105 including a plurality of elements is explained in detail in conjunction with FIG. 2.

FIG. 2 is a block diagram of the server 105, in accordance with one embodiment.

The server 105 includes a bus 205 or other communication mechanism for communicating information, and a processor 210 coupled with the bus 205 for processing information. The server 105 also includes a memory 215, for example a random access memory (RAM) or other dynamic storage device, coupled to the bus 205 for storing information and instructions to be executed by the processor 210. The memory 215 can be used for storing temporary variables or other intermediate information during execution of instructions by the processor 210. The server 105 further includes a read only memory (ROM) 220 or other static storage device coupled to the bus 205 for storing static information and instructions for the processor 210. A storage unit 225, for example a magnetic disk or optical disk, is provided and coupled to the bus 205 for storing information, for example the recommended content. The storage unit 225 can further include databases, for example a topical comments database (DB) 250 and an article database 255.

The server 105 can be coupled via the bus 205 to a display 230, for example a cathode ray tube (CRT), and liquid crystal display (LCD) for displaying the recommended content as links interleaved along with the topical set of comments to the user. An input device 235, including alphanumeric and other keys, is coupled to the bus 205 for communicating information and command selections to the processor 210. Another type of user input device is a cursor control 240, for example a mouse, a trackball, or cursor direction keys for communicating direction information and command selections to the processor 210 and for controlling cursor movement on the display 230. The input device 235 can also be included in the display 230, for example a touch screen.

Various embodiments are related to the use of the server 105 for implementing the techniques described herein. In some embodiments, the techniques are performed by the server 105 in response to the processor 210 executing instructions included in the memory 215. Such instructions can be read into the memory 215 from another machine-readable medium, for example the storage unit 225. Execution of the instructions included in the memory 215 causes the processor 210 to perform the process steps described herein.

In some embodiments, the processor 210 can include one or more processing units, for example a ranking and recommending unit 260, for performing one or more functions of the processor 210. The ranking and recommending unit 260 can retrieve and rank the recommended content. The processing units are hardware circuitry used in place of or in combination with software instructions to perform specified functions.

The term “machine-readable medium” as used herein refers to any medium that participates in providing data that causes a machine to perform a specific function. In an embodiment implemented using the server 105, various machine-readable media are involved, for example, in providing instructions to the processor 210 for execution. The machine-readable medium can be a storage medium, either volatile or non-volatile. A volatile medium includes, for example, dynamic memory, such as the memory 215. A non-volatile medium includes, for example, optical or magnetic disks, for example the storage unit 225. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punchcards, papertape, any other physical media with patterns of holes, a RAM, a PROM, and EPROM, a FLASH-EPROM, any other memory chip or cartridge.

In another embodiment, the machine-readable media can be transmission media including coaxial cables, copper wire and fiber optics, including the wires that comprise the bus 205. Transmission media can also take the form of acoustic or light waves, such as those generated during radio-wave and infra-red data communications. Examples of machine-readable media may include, but are not limited to, a carrier wave as described hereinafter or any other media from which the server 105 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the server 105 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on the storage unit 225 either before or after execution by the processor 210. All such media must be tangible to enable the instructions carried by the media to be detected by a physical mechanism that reads the instructions into a machine.

The server 105 also includes a communication interface 245 coupled to the bus 205. The communication interface 245 provides a two-way data communication coupling to the network 110. For example, the communication interface 245 can be an integrated services digital network (ISDN) card or a modem to provide a data communication connection to a corresponding type of telephone line. As another example, the communication interface 245 can be a local area network (LAN) card to provide a data communication connection to a compatible LAN. Wireless links can also be implemented. In any such implementation, the communication interface 245 sends and receives electrical, electromagnetic or optical signals that carry digital data streams representing various types of information.

The server 105 is also connected to the electronic storage device 120 to store the features of the article, the features of the topical set of comments, the user-intent features, the contextual user-model, the user history, and the user preferences.

The processor 210 in the server 105, for example a Yahoo!® server, determines one or more features of an article on a web page, when the article along with a topical set of comments is being viewed by a user. The processor 210 also defines one or more features of the topical set of comments. The ranking and recommending unit 260 in the processor 210 retrieves the recommended content based on the features of the article and the features of the topical set of comments. The ranking and recommending unit 260 in the processor 210 subsequently ranks the recommended content based on a plurality of parameters including user-intent features, a contextual user-model, user history, and user preferences. Based on the ranking, the recommended content, interleaved as links, along with the topical set of comments is then displayed to the user. The user can use the links to gain information related to the topical set of comments. The links can direct the user either within a network, for example the Yahoo!® network, or to other networks.

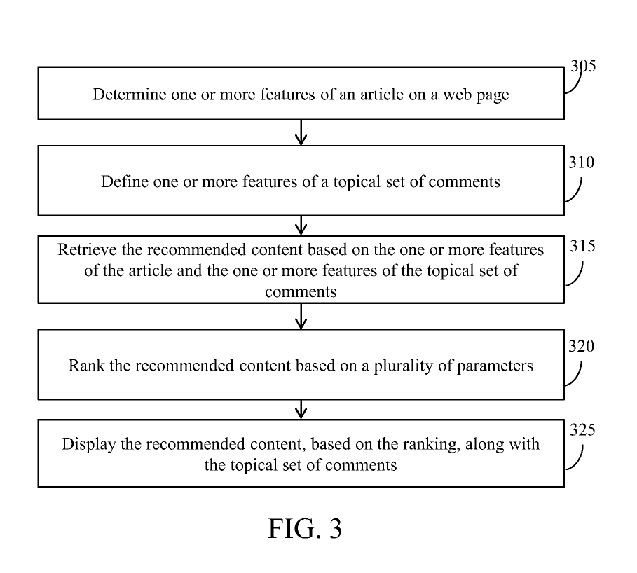

FIG. 3 is a flowchart illustrating a method of providing recommended content for user generated content on an article, in accordance with one embodiment. The user generated content can include comments posted in response to the article or existing comments.

At step 305, one or more features of the article on a web page are determined. The article along with a topical set of comments is being viewed by a user. The topical set of comments is a cluster of comments associated with a topic selected by the user. The features of the article include at least one of domain, time-stamp, representation of a collection of words, and named-entity recognition. Examples of the domain of the article include, but are not limited to, sports domain and news domain. The time-stamp refers to timings at which the article was created or edited. The representation of the collection of words includes words from the article. The named-entity recognition refers to known phrases in the article.

In some embodiments, the topical set of comments is one of multiple topical sets of comments. The topical sets of comments are formed from a set of comments for the article. The topical sets of comments are associated with different topics that are semantically coherent and cohesive. Examples of the different topics can include, but are not limited to, events, individuals, ideologies, sentiments, and literary genre. The user can choose to either read comments grouped by the different topics or read the comments belonging to a few selected topics.

At step 310, one or more features of the topical set of comments are defined. The features of the topical set of comments include at least one of domain, time-stamp, representation of a collection of words, and named-entity recognition. Examples of the domain of the topical set of comments include, but are not limited to, sports domain and news domain. The time-stamp refers to timings at which the topical set of comments was created or edited. The representation of the collection of words includes words from the topical set of comments. The named-entity recognition refers to known phrases in the topical set of comments.

At step 315, the recommended content is retrieved based on the features of the article and the features of the topical set of comments. The recommended content includes articles and topical sets of comments. Relevant topical sets of comments can be retrieved from a topical comments database, for example the topical comments database 250, and relevant articles can be retrieved from an article database, for example the article database 255.

In some embodiments, the recommended content is retrieved using a ranking and recommending unit, for example the ranking and recommending unit 260.

In some embodiments, the articles and corresponding sets of comments are processed using a topical organizer to create interlinked databases, for example the article database 255 and the topical comments database 250.

In some embodiments, the recommended content that is retrieved is referred to as intermediate recommended content.

At step 320, the recommended content is ranked based on a plurality of parameters. The parameters include user-intent features, a contextual user-model, user history, and user preferences.

In some embodiments, the parameters can be stored in an electronic storage device, for example the electronic storage device 120.

The user-intent features are obtained based on pre-determined features of the topical set of comments. The user-intent features approximate probabilities of the user being interested in a pre-determined set of interest-groups, for example sports, war, science, and humor, for reading the topical set of comments on the article. In one embodiment, the user can belong to different interest-groups on reading different articles based on state of mind of the user or subject matter of the different articles.

The contextual user-model is obtained by taking into consideration the user history, for example past browsing behavior, in context of the article and the topic selected by the user.

The user preferences include preferences related to display of the topical set of comments based on, but not limited to, order of comments, geographical location and rating of each commentator.

The user history and the user preferences are further obtained from a user profile of the user.

In some embodiments, the recommended content is ranked using a ranking algorithm.

The recommended content can be stored at the server, for example the server 105, and is retrieved as required. In one example, the server can be a centralized server or a distributed server of Yahoo!®.

At step 325, the recommended content along with the topical set of comments is displayed based on the ranking. In one embodiment, the recommended content, represented as links, is interleaved with the topical set of comments and displayed to the user.

In some embodiments, the links are highlighted to distinguish the links from the topical set of comments. The links are pointers to a related article, a related set of comments for another article, or sponsored content.

In some embodiments, only a portion of the recommended content, having a higher ranking, is displayed to the user.

In some embodiments, the recommended content is displayed in extensible markup language (XML) format or in hypertext markup language (HTML) format.

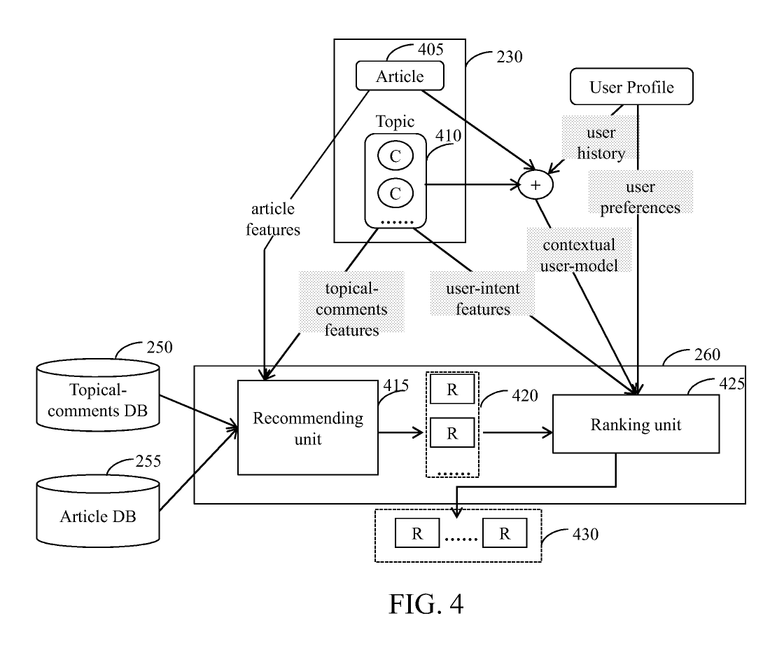

FIG. 4 is a block diagram illustrating working of a ranking and recommending unit, for example the ranking and recommending unit 260, in accordance with one embodiment. In one example, a user visits a web page on Yahoo!® News, via the display 230 of an electronic device, to read an article 405 that discusses a recent tornado in Alabama. The user can choose to read one or more topical sets of comments, for example a topical set of comments 410 discussing a topic of hurricane Katrina. Based on the topical set of comments 410 being read by the user, a processor, for example the processor 210 in the server 105, determines one or more features of the article 405 and one or more features of the topical set of comments 410. Based on the features of the article 405 and the features of the topical set of comments 410, a recommending unit 415 in the ranking and recommending unit 260 retrieves the recommended content from the topical comments database (DB) 250 and from the article DB 255. The recommending unit 415 then generates intermediate recommended content 420.

A ranking unit 425 in the ranking and recommending unit 260 further ranks the intermediate recommended content 420 based on multiple parameters of user-intent features, a contextual user-model, user history, and user preferences. The ranking unit 425 further generates a final recommended content 430. The final recommended content 430 is displayed to the user by interleaving the final recommended content 430, as links, with the topical set of comments 410. Hence, the user can browse through the topical set of comments 410 and, if interested, pursue the links present alongside the topical set of comments 410 in order to gain more information.

The present disclosure provides, to a user, recommended content for user generated content on an article by analyzing a topical set of comments being read by the user. The present disclosure enables generation of personalized recommendations as user-intent is realized when the user browses comments that are topically organized. The present disclosure further enables monetization of the comments by including sponsored links in the recommended content. The present disclosure also increases circulation of network traffic and click-through rate for the recommended content. The method and system in the present disclosure can be used across networks, for example the Yahoo!® network, if each network allows users to post and read comments on different articles.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A method of providing recommended content for user generated content on an article, the method comprising:
determining one or more features of the article on a web page, wherein the article along with a topical set of comments is viewed by a user;
defining one or more features of the topical set of comments;
retrieving the recommended content based on the one or more features of the article and the one or more features of the topical set of comments;
ranking the recommended content based on a plurality of parameters, wherein the plurality of parameters comprises user-intent features, a contextual user-model, user history, and user preferences; and
displaying the recommended content, based on the ranking, along with the topical set of comments.

2. The method as claimed in claim 1, wherein the one or more features of the article comprises at least one of domain, time-stamp, representation of a collection of words, and named-entity recognition.

3. The method as claimed in claim 1, wherein the topical set of comments is associated with a topic selected by the user.

4. The method as claimed in claim 1, wherein the one or more features of the topical set of comments comprises at least one of domain, time-stamp, representation of a collection of words, and named-entity recognition.

5. The method as claimed in claim 1, wherein the recommended content comprises articles and topical sets of comments.

6. The method as claimed in claim 1, wherein the user history and the user preferences are determined from a user profile.

7. The method as claimed in claim 1, wherein displaying the recommended content comprises
interleaving the recommended content with the topical set of comments.

8. The method as claimed in claim 7, wherein the recommended content is displayed as one or more links.

9. The method as claimed in claim 8, wherein the one or more links are highlighted to distinguish the one or more links from the topical set of comments.

10. The method as claimed in claim 8, wherein the one or more links are pointers to at least one of a related article, a related set of comments for another article, and sponsored content.

11. A computer program product stored on a non-transitory computer-readable medium that when executed by a processor, performs a method of providing recommended content for user generated content on an article, comprising:
determining one or more features of the article on a web page, wherein the article along with a topical set of comments is viewed by a user;
defining one or more features of the topical set of comments;
retrieving the recommended content based on the one or more features of the article and the one or more features of the topical set of comments;
ranking the recommended content based on a plurality of parameters, wherein the plurality of parameters comprises user-intent features, a contextual user-model, user history, and user preferences; and
displaying the recommended content, based on the ranking, along with the topical set of comments.

12. The computer program product as claimed in claim 11, wherein the one or more features of the article comprises at least one of domain, time-stamp, representation of a collection of words, and named-entity recognition.

13. The computer program product as claimed in claim 11, wherein the topical set of comments is associated with a topic selected by the user.

14. The computer program product as claimed in claim 11, wherein the one or more features of the topical set of comments comprises at least one of domain, time-stamp, representation of a collection of words, and named-entity recognition.

15. The computer program product as claimed in claim 11, wherein the recommended content comprises articles and topical sets of comments.

16. The computer program product as claimed in claim 11, wherein the user history and the user preferences are determined from a user profile.

17. The computer program product as claimed in claim 11, wherein displaying the recommended content comprises
interleaving the recommended content with the topical set of comments.

18. The computer program product as claimed in claim 17, wherein the recommended content is displayed as one or more links.

19. The computer program product as claimed in claim 18, wherein the one or more links are highlighted to distinguish the one or more links from the topical set of comments.

20. The computer program product as claimed in claim 18, wherein the one or more links are pointers to at least one of a related article, a related set of comments for another article, and sponsored content.

21. A system for providing recommended content for user generated content on an article, the system comprising:
one or more electronic devices;
a communication interface in electronic communication with the one or more electronic devices;
a memory that stores instructions; and
a processor responsive to the instructions to
determine one or more features of the article on a web page, wherein the article along with a topical set of comments is viewed by a user;
define one or more features of the topical set of comments;
retrieve the recommended content based on the one or more features of the article and the one or more features of the topical set of comments;
rank the recommended content based on a plurality of parameters, wherein the plurality of parameters comprises user-intent features, a contextual user-model, user history, and user preferences; and
display the recommended content, based on the ranking, along with the topical set of comments.

22. The system as claimed in claim 21, wherein the processor comprises
a ranking and recommending unit to retrieve and rank the recommended content.

23. The system as claimed in claim 21 and further comprising
an electronic storage device that stores the one or more features of an article, the one or more features of the topical set of comments, the user-intent features, the contextual user-model, the user history, and the user preferences.
